(19) United States
(12) Patent Application Publication
(10) Pub. No.: US 2006/0237285 A1
(43) Pub. Date: Oct. 26, 2006

(54) Diverter for a conveyor

(76) Inventor: Anthony J. DeSanto, Montrose, PA (US)

Correspondence Address: MICHAEL BEST & FRIEDRICH, LLP, 100 E WISCONSIN AVENUE, MILWAUKEE, WI, 53202, US

(21) Appl. No.: 11/111,058

(22) Filed: Apr. 21, 2005

(51) Int. Cl. B65G 47/46

(52) U.S. Cl. 198/361; 198/436; 198/370.03

(57) ABSTRACT

A conveyor section that is operable to move an object along a conveyor path. The conveyor section includes a first roller segment having a first plurality of rollers. Each of the rollers is rotatable about an axis and is angled relative to a horizontal plane. A second roller segment has a second plurality of rollers. Each of the rollers is rotatable about an axis and is angled relative to the horizontal plane such that the first plurality of rollers and the second plurality of rollers are not parallel to one another. The first roller segment and the second roller segment cooperate to support and move the object along the conveyor path.

### BACKGROUND

The present invention relates to a conveyor system. More particularly, the present invention relates to a diverter section of a conveyor that is operable to divert objects substantially vertically.

Conveyors are typically used to move objects or products throughout a factory or warehouse. Often, the conveyor is also used to sort the objects or products being transported. In these applications, the desired destination of the object is determined and the object is diverted from one conveyor to another conveyor that transports the object to the desired location. The diversion can be performed in a substantially horizontal plane using merge sections (e.g., left-hand merge, right-hand merge, etc.). However, horizontal sorting requires a large amount of floor space.

Alternatively, the diversion can be performed in a vertical direction. Typically, vertical diverts employ spiral chutes or elevators driven by chains, screws, gears or other drive mechanisms. These vertical divert systems also typically occupy a large amount of space, thus making it difficult to position a large quantity of divert sections in a small area.

During operation of a conveyor, an object being transported may bounce as it moves across adjacent rollers or sections. In addition, as an object travels along a conveyor, it may skew relative to the conveyor. For example, as an object travels around a curve, the innermost portion (i.e., nearest the center of curvature) travels slower than the outermost portion. This speed variation can skew the product's orientation on the conveyor. Thus, known conveyors and divert sections typically include components that assure that the objects being transported remain in a desired alignment and that the components do not skew. These components can increase the complexity and cost of the conveyor system.

### SUMMARY

The invention provides a conveyor section that is operable to move an object along a conveyor path. The conveyor section includes a first roller segment having a first plurality of rollers. Each of the rollers is rotatable and is angled relative to a horizontal plane. A second roller segment has a second plurality of rollers. Each of the rollers is rotatable and is angled relative to the horizontal plane such that the first plurality of rollers and the second plurality of rollers are not parallel to one another. The first roller segment and the second roller segment cooperate to support and move the object along the conveyor path.

The invention also provides a conveyor system adapted to convey an object along a conveyor path. The conveyor system includes a first section having a first roller segment angled relative to a horizontal plane. A second roller segment is angled relative to the horizontal plane such that the first roller segment and the second roller segment cooperate to at least partially define a channel sized to support and move the object along the conveyor path. The invention also includes a second conveyor section having a third roller segment angled relative to the horizontal plane and a fourth roller segment angled relative to the horizontal plane. The fourth roller segment is movable between a first position in which the third roller segment and the fourth roller segment cooperate to at least partially define a second channel sized to support and move the object along the conveyor path and a second position in which the third roller segment and the fourth roller segment do not support the object and the object is discharged substantially downwardly from the second conveyor section.

The invention further provides a conveyor system adapted to transport an object. The conveyor system includes a first conveyor that is operable to transport the object along a first conveyor path. A second conveyor includes a plurality of conveyor sections at least partially disposed above the first conveyor and operable to transport the object along a second conveyor path. At least one of the conveyor sections includes a fixed roller segment including a plurality of rollers. A movable roller segment includes a plurality of rollers. The movable roller segment is disposed opposite the fixed roller segment to at least partially define a channel sized to receive the object for transport along the first conveyor path. An actuator is operable to move the movable roller segment between a first position in which the object is transported along the second conveyor path and a second position in which the object is transferred substantially downwardly from the second conveyor to the first conveyor.

### BRIEF DESCRIPTION OF THE DRAWINGS

FIG. 1 is a perspective view of a conveyor system including a first conveyor and a second conveyor;

FIG. 2 is a schematic end view of a diverter section of the second conveyor of FIG. 1 in a first position and including a tray;

FIG. 3 is a schematic end view of a diverter section of the second conveyor of FIG. 1 in a second position;

FIG. 4 is a schematic top view of the diverter section of FIG. 2 including the tray;

FIG. 5 is a schematic end view of the diverter section of FIG. 2 positioned over a two-direction roller conveyor;

FIG. 6 is a schematic end view of the diverter section of FIG. 2 positioned over a single-direction roller conveyor;

FIG. 7 is a schematic illustration of a conveyor system including four diverter sections and four two-direction roller conveyors;

FIG. 8 is a schematic illustration of two empty tray buffers arranged to deliver empty trays to a sorter; and

FIG. 9 is an enlarged end view of a cam mechanism operable to move the second conveyor from the first position illustrated in FIG. 2 to the second position illustrated in FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

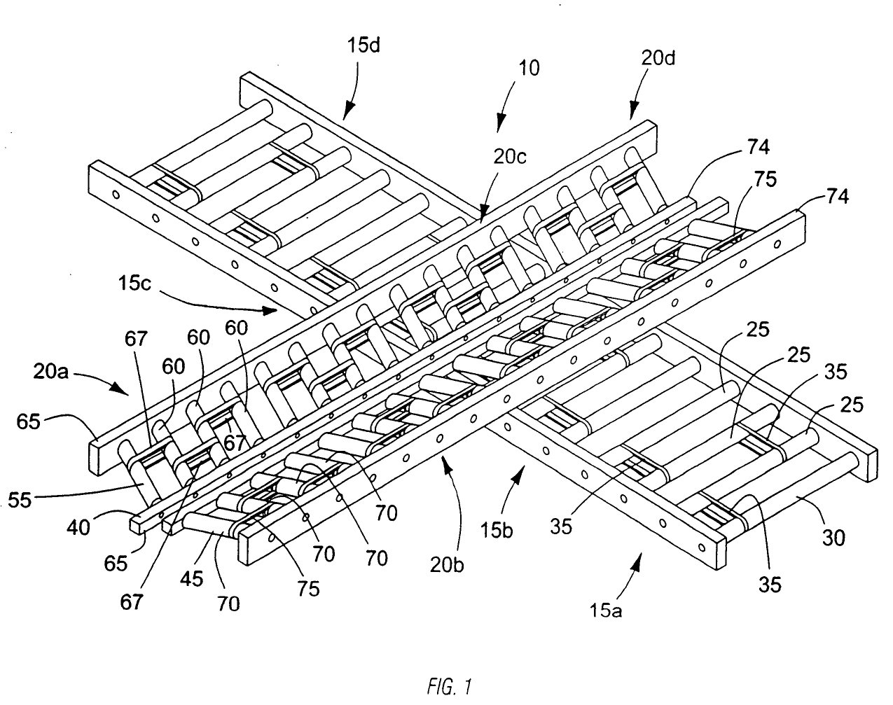

FIG. 1 illustrates a simple conveyor system 10 that includes a first conveyor 15 and a second conveyor 20. The first conveyor 15 is a flat roller conveyor that is well known in the conveyor art. Generally, conveyors 15 of this type include a plurality of conveyor sections 15a, 15b, 15c, 15d. Each section 15a, 15b, 15c, 15d includes a plurality of idler rollers 25 that are arranged horizontally such that they are able to support an object that is being transported by the conveyor 15. One power roller 30 in each conveyor section 15a, 15b, 15c, 15d is powered for rotation about the long axis of the roller 30. Power can be provided by an electric motor disposed within the roller 30 or disposed outside of the roller 30 as is well known in the art of conveyors. As illustrated in FIG. 1, the powered roller 30 is coupled to the adjacent idler roller 25 in the section 15a, 15b, 15c, 15d via a belt. Similarly, the second idler roller is connected to the first idler roller via a belt 35. The remaining idler rollers are coupled to one another in a manner similar to that just described. With the rollers 25, 30 coupled as illustrated in FIG. 1, rotation of the powered roller 30 produces a similar rotation of the idler rollers 25 and propels the object through the particular conveyor section 15a, 15b, 15c, 15d.

As illustrated in FIG. 1, each conveyor section 15a, 15b, 15c, 15d includes one powered roller 30 and three idler rollers 25. Of course, other conveyor sections may include more or less idler rollers 25 or more powered rollers 30 as desired. The actual construction of the first conveyor 15 is not critical to the function of the invention. In fact, the first conveyor 15 is not necessary for the invention to function. As such, the invention should not be limited to constructions that include a first conveyor 15 as described, or even to a construction that includes the first conveyor 15.

The second conveyor 20 is illustrated in FIG. 1 in one possible position in which it is disposed above the first conveyor 15 and is angled relative to the first conveyor 15. As with the first conveyor 15, the second conveyor 20 includes a plurality of sections 20a, 20b, 20c, 20d. Each section 20a, 20b, 20c, 20d includes a first row of rollers that define a first roller segment 40 and a second row of rollers that define a second roller segment 45. The first roller segment 40 is disposed opposite the second roller segment 45 and angled relative to the first roller segment 40 to define a channel 50. In most constructions, the channel 50 defines a trapezoidal cross section with the small length being disposed at the bottom of the channel 50 as shown in FIG. 2. However, other constructions may employ different shaped channels 50. In preferred constructions, each of the first and second roller segments 40, 45 are positioned at an angle of at least about ten degrees relative to a vertical. Of course, greater or smaller angles could be employed if desired.

The first roller segment 40 in each conveyor section 20a, 20b, 20c, 20d includes at least one powered roller 55 supported for rotation about a long axis. As with the powered rollers 30 of the first conveyor 15, power can be provided by an electric motor disposed within the roller or outside the roller. In addition, alternative power supplies can also be used if desired (e.g., hydraulic, pneumatic, etc.). The first roller segment 40 in each conveyor section 20a, 20b, 20c, 20d also includes at least one idler roller 60, with several idler rollers 60 being preferred. A pair of opposed support members 65 support the idler rollers 60 and the powered roller 55 for rotation about their respective long axes, and maintain the desired spacing between the rollers 55, 60. The idler rollers 60 are arranged such that they are substantially parallel to one another and parallel to the powered roller 55, with other arrangements being possible. A belt 67 provides for a rotational connection between the first idler roller 60 and the powered roller 55. Similarly, other belts interconnect the remaining idler rollers 60 of the first roller segment 40 of each conveyor section 20a, 20b, 20c, 20d. The described connections assure that rotation of the powered roller 55 produces a similar rotation of the idler rollers 60 in each of the first roller segments 40 of the conveyor sections 20a, 20b, 20c, 20d. In the construction illustrated in FIG. 1, each conveyor section 20a, 20b, 20c, 20d includes one powered roller 55 and three idler rollers 60. Of course other constructions could employ different quantities of powered rollers 55 (i.e., more than one) and/or idler rollers 60 (i.e., more or less than three) if desired.

The second roller segment 45 in each conveyor section 20a, 20b, 20c, 20d includes at least one idler roller 70. In most constructions, several idler rollers 70 are employed with the number of idler rollers 70 being substantially equal to the number of rollers 55, 60 in the first roller segment 45 for the particular conveyor section 20a, 20b, 20c, 20d. A pair of opposed support members 74 support the ends of the rollers 70 for rotation about their respective long axes and interconnect the rollers 70 to maintain the desired spacing and orientation. Again, the rollers 70 are generally parallel to one another with other arrangements being possible. Belts 75 are employed to connect each of the idler rollers 70 of a conveyor section 20a, 20b, 20c, 20d to the adjacent roller 70, or rollers 70, for rotation. Thus, rotation of one of the idler rollers 70 will produce a corresponding rotation of all of the idler rollers 70 in the second roller segment 45 of the particular conveyor section 20a, 20b, 20c, 20d.

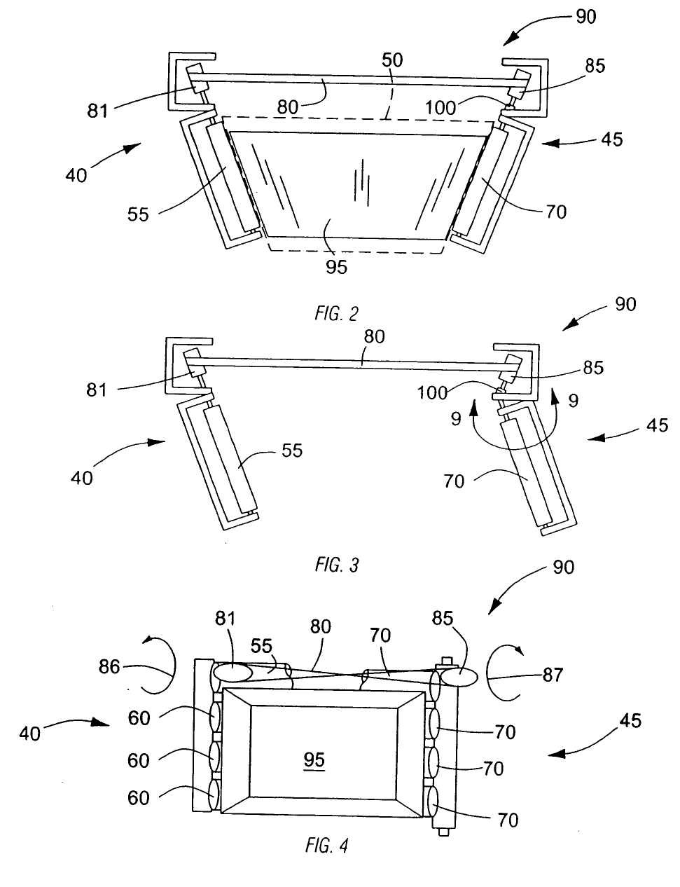

As illustrated in FIGS. 2-4, a twisted cross belt 80 couples the rollers 55, 60 of the first roller segment 40 of a particular conveyor section 20a, 20b, 20c, 20d to the rollers 70 of the second roller segment 45 of that conveyor section 20a, 20b, 20c, 20d. Generally, the belt 80 connects to the powered roller 55, or to a drive axle 81 that extends from the roller 55 and to a drive hub 85. The drive hub 85 engages the roller 70 that is directly across from the powered roller 55. Of course, any two rollers 55, 60,70 within the conveyor section 20a, 20b, 20c, 20d can be coupled to one another, so long as they are not both disposed within a common roller segment 40, 45. The twist in the belt 80, as illustrated in FIG. 4, allows the rollers 55, 60 of the first roller segment 40 to rotate in a first direction 86 (e.g., counterclockwise as viewed from the top), while the rollers 70 of the second roller segment 45 rotate in the opposite direction 87(e.g., clockwise as viewed from the top).

Before proceeding it should be noted that while belts 35, 67, 75, 80 have been described as being used to interconnect adjacent rollers and roller segments, other connection means are also possible. For example, gears or chains could be used to interconnect adjacent rollers or could provide the rotational connection between the first and second roller segments 40, 45. In yet another construction, an electrical connection (e.g., synchronized motors) is employed to assure the desired rotation of the rollers. As one of ordinary skill will realize, many other devices or arrangements could be used in place of the belts 35, 67, 75, 80 described.

With reference to FIG. 1, at least one of the illustrated conveyor sections 20a, 20b, 20c, 20d is a diverter section 90. The diverter section 90 can discharge an object being transported along the second conveyor 20 in a substantially downward direction. Thus, the diverter section 90 is able to redirect an object from the second conveyor 20, downward to the first conveyor 15.

FIG. 2 illustrates the diverter section 90 of FIG. 1 supporting a tray 95. As illustrated, the first roller segment 40 is fixed, while the second roller segment 45 is movable. Specifically, the second, or movable roller segment 45, is pivotable between a first position (shown in FIG. 2) in which it cooperates with the first roller segment 40 to define the channel 50, and a second position (shown in FIG. 3) in which the movable roller segment 45 moves to a position that allows for the discharge of the tray 95 being transported.

In another construction, both the first roller segment 40 and the second roller segment 45 are movable. With both roller segments 40, 45, the tray 95 drops along a very nearly vertical path. Before proceeding further, it should be noted that the tray 95 when transferred downwardly travels along a path that has a vertical component and may also have a component that is parallel to the conveyor path and perpendicular to the conveyor path. For example, if a tray 95 is transferred while it is moving along the conveyor path, some of the forward momentum will continue as the tray drops to the second elevation. Furthermore, if only one of the roller segments 40, 45 moves, the tray 95 will slide along the stationary roller segment 40, 45 which will impart some lateral movement on the tray 95.

To achieve the desired movement of the second roller segment 45, the opposed support members 74 that support the rollers 70 pivot. The drive hub 85 remains substantially stationary to maintain the tension and position of the belt 80 during the movement of the movable roller segment 45. As such, a flexible drive connection 100 (e.g., U-joint, ball and socket drive, etc.) is positioned between the drive hub 85 and the roller 70 that is driven by the drive hub 85. The belts 75 directly connect the idler rollers 70 to one another and pivot with the rollers 70, thus eliminating any need for additional flexible drive connections.

While many devices are able to produce the desired movement of the movable roller portion 45, the construction illustrated in FIG. 9 includes a cam 105 that engages a frame member 101 of the movable roller portion 45 and holds it in the first position. A gear motor 106 includes a pinion gear 107 that engages a drive gear 108, which in turn rotates the cam 105 to move the movable roller portion 45. When the cam 105 is rotated, gravity moves the movable roller portion 45 to the second position. The cam 105 is then rotated back to push the movable roller portion 45 back to the first position. The cam 105 is contoured to move the movable roller segment 45 gradually into the first position. In the construction illustrated in FIG. 9, a rotation of about 270 degrees is required to move from the second position (illustrated in FIG. 9) to the first position (illustrated in FIG. 2). The gradual transition reduces the torque required and allows for the use of a smaller low-power motor. Other mechanisms suited to moving the movable roller portion 45 include, but are not limited to, hydraulic or pneumatic actuators, electric servomotors, linear motors, and the like. In addition, gearboxes or other torque increasers can be employed to further reduce the force required to move the movable roller portion 45.

With reference to FIGS. 2 and 3, one of ordinary skill will realize that the illustrated conveyor 20 is able to support a tray 95, discharge the tray 95 in a vertical or nearly vertical direction, and inhibit unwanted skewing of the tray 95 as it moves along the conveyor 20. The angle of the rollers 55, 60 of the first roller segment 40 and the rollers 70 of the second roller segment 45 are such that they substantially match the angles of the sides of the tray 95. Of course, the angles could be varied to accommodate various trays 95 or other objects being transported by the conveyor 20.

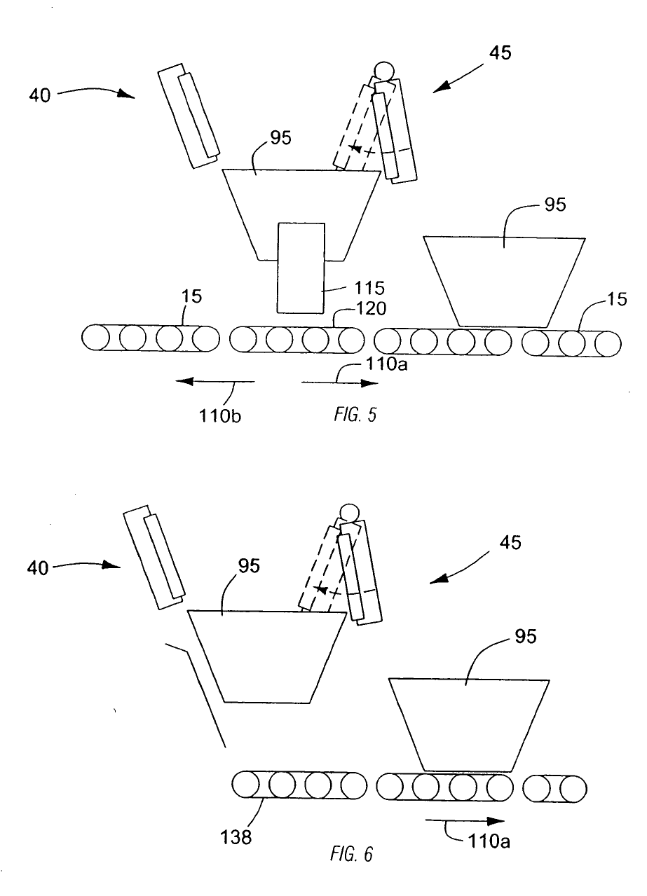

FIG. 5 illustrates one possible application in which the diverter section 90 is operable to divert trays 95 in one of two directions 110a, 110b and the second conveyor 20 is operable to selectively deliver trays 95 to the first conveyor 15. As a tray to be diverted 95 passes over the first conveyor 15, the movable roller portion 45 moves to the second position and the tray 95 falls toward the first conveyor 15. A guide 115 is positioned to inhibit any forward motion (i.e., normal to the first conveyor 15). Once the tray 95 is positioned on a receiving section 120 of the first conveyor 15, the receiving section 120 is powered to deliver the tray 95 in either a first direction 110a or a second direction 110b.

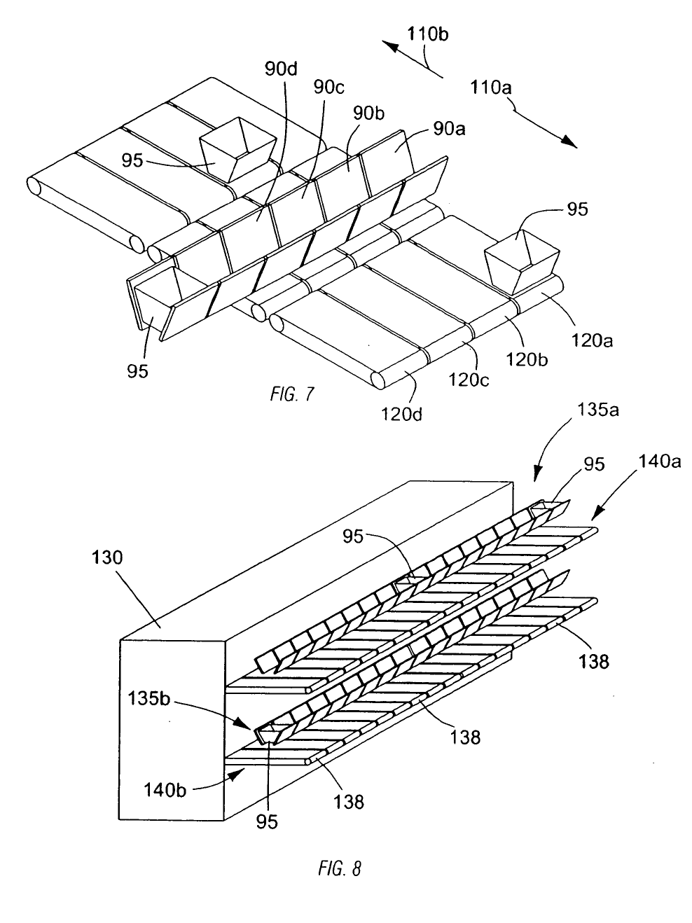

FIG. 7 schematically illustrates an application in which four conveyors 120a, 120b, 120c, 120d are positioned beneath a diverting conveyor 125. The diverting conveyor 125 can include as few as four diverter sections 90a, 90b, 90c, 90d (i.e., one diverter section for each conveyor 120a, 120b, 120c, 120d). Each diverter section 90a, 90b, 90c, 90d would be similar to the one illustrated in FIG. 5 and would be positioned over one of the four conveyors 120a, 120b, 120c, 120d. The tray 95 passes along the diverting conveyor 125 until it reaches the diverter section 90a, 90b, 90c, 90d disposed over the conveyor 120a, 120b, 120c, 120d to which it is to be diverted. The movable roller segment 45 of the diverter section 90a, 90b, 90c, 90d, shown in FIG. 5, opens and the tray 95 drops to the conveyor 120a, 120b, 120c, 120d. The conveyor 120a, 120b, 120c, 120d is then powered to deliver the tray 95 in one of two directions 110a, 110b. Thus, this application is able to deliver trays to one of eight paths in a space that is approximately the size of four conveyor sections.

FIG. 6 illustrates another application in which the first conveyor section 15 redirects the tray 95 in only one direction 110a. This application allows for a ninety-degree change in direction of the diverted tray 95 in the space of a single conveyor section.

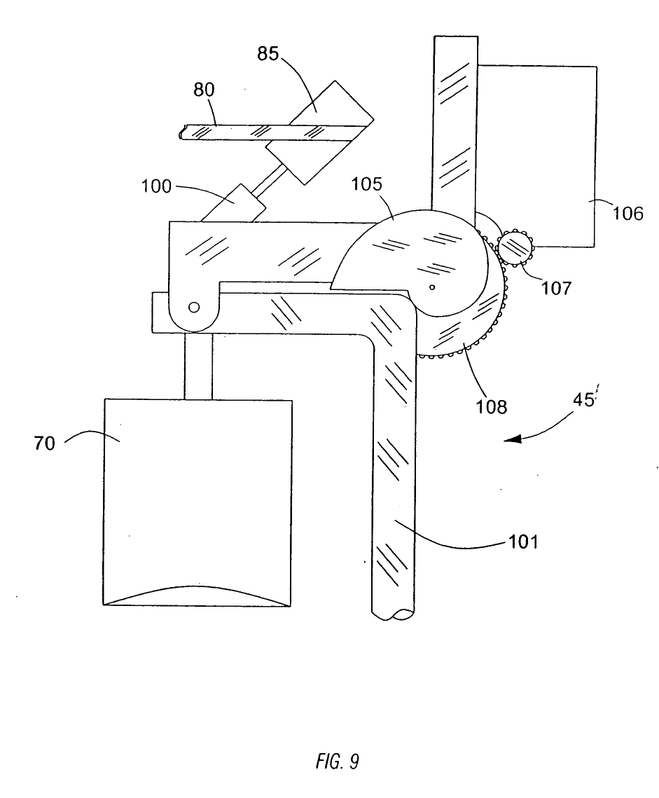

FIG. 8 illustrates an application that is well-suited to using the arrangement illustrated in FIG. 6. FIG. 8 schematically illustrates an arrangement that feeds empty trays 95 into a sorter 130. Two empty tray buffers 135a, 135b are disposed above a plurality of empty tray inject queues 138. The plurality of empty tray inject queues 138 is represented by two elongated rectangles 140a, 140b in FIG. 8. Each elongated rectangle can represent one hundred or more (or less) empty tray inject queues 138. When a tray 95 is needed at one of the queues 138, the tray is moved along one of the empty tray buffers 135a, 135b until it is positioned directly above the appropriate empty tray inject queue 138. The movable roller portion 45 of the section above the queue 138 moves to the second position and the tray 95 is dropped into the injection queue 138. Using this arrangement, two conveyors 135a, 135b can be used to deliver trays 95 to well over one hundred inject queues 138 if desired.

In operation, the conveyor 20, such as the one shown in FIGS. 1-4 feeds objects, such as trays 95, along a conveyor path that may include one or more diverter sections 90. In some constructions, a roller conveyor, similar to the first conveyor 15 of FIG. 1, feeds objects into the diverter section 90 or receives objects that pass through the diverter section 90. The powered roller 55 within the first roller segment 40 rotates to drive the powered roller 55 and the idler rollers 60 of the first roller segment 40. In addition, rotation of the powered roller 55 rotates the rollers 70 of the second roller segment 45. Thus, rotation of the powered roller 55 rotates all of the rollers 55, 60, 70 of the diverter section 90 at the same speed. As the tray 95 enters the diverter section 90, it engages the rollers 55, 60, 70 and is moved along the conveyor path. The arrangement of the rollers 55, 60, 70 inhibits skewing of the tray 95 as it is being transported. If no diversion of the tray 95 is desired, the tray 95 passes through the diverter section 90 and continues along the conveyor path. If a diversion is desired, the cam 105 is rotated to release the second roller segment 45. The tray 95, no longer supported by both roller segments 40, 45, falls to the first conveyor 15 disposed beneath the second conveyor 20. After the tray 95 drops, the first conveyor 15 directs it along the new path and the cam 105 rotates to move the second roller segment 45 back into a position that is able to support another tray 95 that may enter the diverter section 90.

Thus, the invention provides, among other things, a conveyor 20 that is able to deliver objects in a vertical or nearly vertical direction within a confined space. Various features and advantages of the invention are set forth in the following claims.

What is claimed is:

1. A conveyor section operable to move an object along a conveyor path, the conveyor section comprising:
a first roller segment having a first plurality of rollers, each of the rollers angled relative to a horizontal plane; and
a second roller segment having a second plurality of rollers, each of the rollers angled relative to the horizontal plane such that the first plurality of rollers and the second plurality of rollers are not parallel to one another, the first roller segment and the second roller segment cooperating to support and move the object along the conveyor path.

2. The conveyor section of claim 1, wherein the first roller segment and the second roller segment cooperate to at least partially define a trapezoidal channel sized to receive the object.

3. The conveyor section of claim 1, further comprising a drive mechanism coupled to one of the rollers of the first plurality of rollers.

4. The conveyor section of claim 3, further comprising a plurality of drive connectors interconnecting each of the rollers of the first roller segment and each of the rollers of the second roller segment such that the drive mechanism rotates each roller of the first roller segment and each roller of the second roller segment.

5. The conveyor section of claim 4, wherein at least one of the drive connectors is a twisted cross belt that facilitates rotation of the rollers of the first roller segment in a direction opposite to the direction of rotation of the rollers of the second roller segment.

6. The conveyor section of claim 1, wherein the object is a tray having angled side surfaces, the first roller segment and the second roller segment angled to substantially correspond with the angled side surfaces.

7. The conveyor section of claim 1, wherein the first plurality of rollers is fixed with respect to the conveyor path, and the second plurality of rollers is pivotable with respect to the conveyor path.

8. The conveyor section of claim 7, further comprising an actuator operable to move the second plurality of rollers between a first position in which the object is moved along the conveyor path and a second position in which the object is free to move substantially normal to the conveyor path.

9. The conveyor section of claim 1, wherein the first plurality of rollers and the second plurality of rollers are pivotable with respect to the conveyor path.

10. The conveyor of claim 9, wherein the first plurality of rollers and the second plurality of rollers pivot to transfer the object in a substantially vertical direction.

11. A conveyor system adapted to transport an object, the conveyor system comprising:
a first conveyor operable to transport the object along a first conveyor path; and
a second conveyor including a plurality of conveyor sections at least partially disposed above the first conveyor and operable to transport the object along a second conveyor path, at least one of the conveyor sections including:
a fixed roller segment including a plurality of rollers;
a movable roller segment including a plurality of rollers, the movable roller segment disposed opposite the fixed roller segment to at least partially define a channel sized to receive the object for transport along the first conveyor path; and
an actuator operable to move the movable roller segment between a first position in which the object is transported along the second conveyor path and a second position in which the object is transferred substantially downwardly from the second conveyor to the first conveyor.

12. The conveyor system of claim 11, wherein the channel has a cross section that is substantially trapezoidal.

13. The conveyor system of claim 11, further comprising a drive mechanism coupled to at least one of the rollers of the movable roller segment and the fixed roller segment.

14. The conveyor system of claim 13, further comprising a plurality of drive connectors interconnecting each of the rollers such that the drive mechanism rotates each roller.

15. The conveyor system of claim 14, wherein at least one of the drive connectors is a twisted cross belt that interconnects the rollers of the fixed roller segment and the rollers of the movable roller segment such that the rollers of the fixed segment rotate in the opposite direction as the rollers of the movable roller segment.

16. The conveyor system of claim 11, wherein the object is a tray having angled side surfaces and a tray length, the fixed roller segment and the movable roller segment angled to substantially correspond with the angled side surfaces.

17. A method of transferring an object from a first elevation to a second elevation, the method comprising:
positioning a first roller segment and a second roller segment such that the second roller segment is spaced apart from the first roller segment and is not parallel to the first roller segment;
supporting the object at the first elevation using the first roller segment and the second roller segment; and
moving the first roller segment relative to the second roller segment to discharge the object substantially downwardly to the second elevation.

18. The method of claim 17, further comprising pivoting the second roller segment relative to the first roller segment to discharge the object to the second elevation.

19. The method of claim 17, further comprising supporting a plurality of rollers in the first roller segment and the second roller segment and rotating the plurality of rollers to move the object along a conveyor path.

20. The method of claim 19, wherein the conveyor path is substantially horizontal and the plurality of rollers are arranged at non-zero angles relative to the conveyor path.
